(19) United States
(12) Patent Application Publication
(10) Pub. No.: US 2010/0176287 A1
(43) Pub. Date: Jul. 15, 2010

(54) DEVICE FOR SEPARATION AND MALDI ANALYSIS OF AN ANALYTE IN A SAMPLE

(75) Inventors: Carolina Ribbing, Eindhoven (NL); Ove Cornelis Ohman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,037

(22) PCT Filed: Nov. 21, 2007
(86) PCT No.: PCT/IB07/54736

§ 371 Date: Jan. 29, 2010

(30) Foreign Application Priority Data
Nov. 23, 2006 (EP) 06124678.1

(51) Int. Cl. H01J 49/16; B01D 59/44

(52) U.S. Cl. 250/282; 250/288

(57) ABSTRACT

The present invention relates to a device for separating at least one analyte in a liquid sample and further analyzing said analyte by laser desorption/ionization (LDI) mass spectrometry. The invention is further concerned with the use of devices for separating at least one analyte in a liquid sample and subsequent determination of the presence and/or amount of said at least one analyte by LDI mass spectrometry. The invention is also concerned with a method for separating at least one analyte in a liquid sample and subsequent determination of the presence and/or amount of said at least one analyte by LDI mass spectrometry.

### FIELD OF THE INVENTION

The present invention relates to a device for separating at least one analyte in a liquid sample and further analyzing said analyte by laser desorption/ionization (LDI) mass spectrometry.

The invention is further concerned with the use of devices for separating at least one analyte in a liquid sample and subsequent determination of the presence and/or amount of said at least one analyte by LDI detection.

The invention is also concerned with a method for separating at least one analyte in a liquid sample and subsequent determination of the presence and/or amount of said at least one analyte by LDI mass spectrometry.

### BACKGROUND OF THE INVENTION

Bioassays are used to probe for the presence and/or the quantity of an analyte in a biological sample. A typical application of such bioassays are in vitro diagnostic methods which have become more common over the years and increasingly complement or even replace more traditional diagnostic approaches like palpation, vasculation, diagnostic imaging, endoscopy and biopsy taking.

A lot of the bioassays that are commonly used today also in the field of in vitro diagnostics are so-called surface-based assays. Examples of surface-based assays are e.g. DNA microarrays, microtitre plate-based ELISAs or radioimmunoprecipitation assays, etc.

A major hurdle in these and other bioassays remains sample preparation. The often elaborate methods required for the preparation of a sample frequently include a large number of critical steps such as a lysis of e.g. cellular samples, denaturation of proteins, etc. that potentially can have a negative influence on the sensitivity and the accuracy of the assay. For example, in case of DNA microarrays and microtitre plate-based ELISAs, the noise contribution from sample preparation remains a factor to be taken into account when validating an in vitro diagnostic test.

For some applications, mass spectrometry methods are increasingly replacing other bioassays as the method of choice. Efforts to improve the sensitivity and throughput capabilities of mass spectrometry-based assays have resulted in the development of a number of mass spectrometric formats for the analysis of samples of biological relevance. In addition to the innovations in mass spectrometry technologies (laser sources, matrix materials, detection units), substrates that more efficiently and specifically absorb an analyte have been attempted and the early designs have been improved upon.

Direct laser desorption/ionisation of biomolecules as originally performed for mass spectrometry generally results in fragmentation of large biomolecules such as polypeptides and nucleic acids. To achieve desorption/ionisation of intact biomolecules of several 10-100 kDa, various techniques have been used.

One particularly suitable methodology which is commonly referred to as matrix assisted laser desorption/ionization mass spectrometry (MALDI-MS) uses biomolecules which are mixed in solution with an energy absorbing organic molecule (EAM) which is referred to as the matrix material. Typically the matrix is allowed to crystallize on a mass spectrometry probe capturing biomolecules within the matrix.

In MALDI-MS the analyte which typically are biological molecules is thus mixed with a solution containing a matrix and a drop of the liquid is placed on the surface of a probe. The matrix solution then co-crystallizes with the biological molecules. The probe is inserted into the mass spectrometer and laser energy is then directed to the probe surface where it desorbs and ionizes the biological molecules without significantly fragmenting them. In other embodiments of MALDI-MS, the matrix is first crystallized as a thin film with the biomolecules being added later on or vice versa. However, MALDI-MS has limitations as an analytical tool. It thus does not provide means for fractionating the sample and a complex biological liquid such as blood is not suitable for MALDI-MS without prior preparatory steps.

These problems have been partially accounted for by further development such as surface-enhanced laser desorption/ionisation mass spectrometry (SELDI-MS).

In SELDI-MS, the probe surface is modified so that it forms an active participant in the sample preparation process. In one variant the surface is for example derivatized with affinity reagents that selectively bind the analyte of interest. In another variant the surface is derivatized with chromatographic moieties that bind a subgroup of sample molecules. In yet another variant, the surface is derivatized with energy absorbing molecules that are not desorbed when probed with a laser. In still another variant, the surface is derivatized with molecules that bind the analyte and that contain a photolytic bond that is broken upon application of the laser.

SELDI is thus the combination of a selective surface MS target with MALDI-MS. However, SELDI does not necessarily include immobilized matrix on the MS target - this variant is typically called SEND.

The principles of MALDI and SELDI are e.g. put forward in detail in e.g. U.S. Pat. No. 5,118,937, U.S. Pat. No. 5,045,694, U.S. Pat. No. 5,719,060 and US 2002/0060290 A1.

The SELDI technology has been commercialized by Ciphergen Biosystems Inc. in the form of the so-called ProteinChip® platform. As can be taken from the applications guide for the ProteinChip®, parallel analysis of biological samples is possible in that individual chromatographic chips are accommodated in a special holder to achieve a microtitre-like plate format. After sample incubation on chips, unbound molecules are removed e.g. by buffer washing and a MALDI-MS measurement is performed directly off the chromatographic surface. The matrix may be either added as a last step before MS measurement or it is already covalently bound to the chip surface.

Even though the above-described SELDI as well as MALDI approaches constitute major advancements as regards the high throughput multi-factorial analysis of biological samples, hurdles remain which should be overcome for developing robust, mass spectrometry based in vitro diagnostic methods.

As set out in the beginning most of today's problems are related to sample handling and preparation as well as the rather complex automation requirements for multi-factorial analysis.

If for example, in SELDI technology a multi-factorial analysis is to be performed, different affinity surfaces have to be created which have to be probed with different samples separately. This means that no convenient multiplexing is possible. Further, the sample preparation and analysis is performed near (in time and space) the detection unit and usually requires a wet-chemistry environment.

As the different surface spots have to be probed separately, SELDI technology usually also requires numerous washing steps and correspondingly ideally a significant degree of automation.

In view of this situation, there is a continuing need for devices and methods that allow combining the separation of analytes from biological samples in a convenient manner without the need for extensive constructive elements.

### OBJECTS AND SUMMARY OF THE INVENTION

It is an object of the present invention to provide a device which can be used for separating analytes in a liquid sample and which can be directly used for analysis of the presence and/or amount of the analyte by mass-spectrometry methods such as MALDI-MS.

It is a further object of the present invention to provide methods for separating analytes from liquid samples and determining the presence and/or amount of said analytes by mass spectrometry methods such as MALDI-MS.

These and other objects of the present invention as they will become apparent from the ensuing description are solved by the subject matter of the independent claims. The dependent claims relate to preferred embodiments of the invention.

The present invention relates in one aspect to a device for separating at least one analyte in a liquid sample comprising at least one substrate with:
at least one zone for loading a liquid sample;
at least one zone for transporting said liquid sample;
at least one zone for separating said at least one analyte from other components of said liquid sample; and
at least one zone for laser desorption ionization (LDI) mass spectrometry detection;
wherein said at least one transport zone comprises an array of elevated structures of a form, dimensions and spacing in between said elevated structures such that a capillary force-driven flow of said sample from said loading zone trough said separation zone to said LDI detection zone is achieved.

The elevated structures can have different forms including a round shape, a cylindrical shape, a rectangular shape, a triangular shape, etc.

The height of these elevated structures will typically be higher than approximately 1 μm and lower than 1000 μm.

The width and length of these elevated structures will typically be the height times a factor 0.5-1, e.g. 5-10 μm for a 10 μm high structure.

On the detection area, which is used as platform for LDI, the pillars will typically be <50 μm height in order not to impair the mass resolution in the time-of-flight MS measurement.

The spacing between these elevated structures which may have a pillar-like appearance is chosen to ensure a capillary force-driven transport of the liquid sample from the loading zone through the separation zone to the LDI detection zone. The spacing will typically be in a range of approximately 0.1 to approximately 1000 μm.

The separation zone may be located adjacent to and/or in the loading zone, the transport zone and/or the LDI detection zone. The separation zone may provide a physical, chemical and/or biological functionality in order to allow separation of the at least one analyte from other components of the liquid sample.

A physical functionality may be provided by the form, dimensions and/or the spacing as well as the topography of the distribution of the same type of elevated structures as they are used in the transport zone.

Chemical functionalities may be provided by e.g. different coatings. Thus, a chemical functionality may be provided by a hydrophobic polymer coating. Alternatively and/or additionally a chemical functionality may be provided by ionic polymer coating such as a poly-anion exchange coating.

A biological functionality will be provided by all type of molecules that will ensure a specific biological interaction with a component of the sample to be separated. Thus, biological functionalities include antibodies, receptor molecules, nucleic acid molecules and/or small molecule inhibitors which are coated in the separation zone e.g. on the pillar-like structures.

The zone for LDI detection comprises at least one metal and/or at least one energy absorbing molecule (EAM) being capable for use as matrix material in matrix assisted laser desorption ionization mass spectrometry (MALDI-MS) and/or at least one calibrant.

The LDI detection zone will comprise a metal or alloy preferably selected from the group comprising silver, gold, platin, palladium, chromium, titanium and copper with adhesion layer of e.g. chromium and/or titanium. Alternatively and/or additionally, the LDI detection zone will comprise energy absorbing molecules (EAM) as they are typically used as matrix materials in MALDI-MS detection. Thus, such molecules may be selected from the group comprising derivatives of benzoic acid, cinnamic acid, and related aromatic compounds, e.g. 2,5-dihydroxybenzoic acid (2,5-DHB or gentisic acid), α-cyano-4-hydroxy cinnamic acid (CHCA), 3,5-dimethoxy-4-hydroxy cinnamic acid (sinapic acid, sinapinic acid or SPA), nicotinic acid, picolinic acid, trans-3-methoxy-4-hydroxy cinnamic acid (ferulic acid) 2-(4-hydroxyphenylazo)-benzoic acid (HABA), 6-aza-2-thiothymine (ATT), 3-HPA, succinic acid, glycerol, 4-hydroxypicolinic acid, tartaric acid, glycerine, 2,4,6-trihydroxy acetophenone, 3-hydroxypicolinic acid, 3-aminoquinoline, 1,8,9-trihydroxy-anthracene (dithranol), the laser dye coumarin 120, substituted pyrimidines, pyridines, and anilines, e.g. para-nitroaniline.

The calibrant may any molecular species as it is commonly used for reference and calibration purposes in MALDI-MS.

The liquid sample may be an environmental sample, a sample taken from an animal or a human being, from provisions/food-stuffs or from plants. Further specifics are set out below.

In another embodiment, the present invention relates to a method of determining the presence and/or amount of at least one analyte in a sample comprising the steps of:
a) providing a device for separating at least one analyte in a liquid sample comprising at least one substrate with:
   at least one zone for loading a liquid sample;
   at least one zone for transporting said liquid sample; and
   at least one zone for separating said at least one analyte from other components of said liquid sample;
wherein said at least one transport zone comprises an array of elevated structures of a form, dimensions and spacing in between said elevated structures such that a capillary force-driven flow of said sample from said loading zone trough said separation zone is achieved;
b) loading a liquid sample onto the loading zone of said device of step a);
c) separating said at least one analyte from other components of a said sample using said device of a);
d) determining the presence and/or amount of said at least one analyte by LDI.

It is noted that in this embodiment of the present invention, the device does not necessarily comprise an LDI detection zone with at least one metal and/or at least one energy absorbing molecule (EAM) being capable for use as matrix material in matrix assisted laser desorption ionization mass spectrometry (MALDI-MS) and/or at least one calibrant. Nevertheless, the presence of such LDI detection zones as described above can constitute a preferred embodiment of the present invention.

The separation zone may again be located adjacent to and/or in the loading zone, the transport zone and/or the LDI detection zone(s) if the latter is (are) present. Of course, the separation zone may be physically, chemically or biologically functionalized as described above.

The nature of the sample can again be the same as described above.

The methods in accordance with the invention can be used to transport a liquid sample along the transport zone and separate it in the at least one separation zone. Then, the presence and/or amount of an analyte are determined by LDI-based mass spectrometry such as MALDI-MS by inserting the device directly into a corresponding mass spectrometer.

The present invention also relates to the use of the afore-described devices for separating analytes within a liquid sample and determining the presence and/or amount by LDI-based mass spectrometry such as MALDI-MS. The devices at minimum comprise a zone for loading the liquid sample, a zone for transporting the liquid sample and a zone for separating at least one analyte from other components of the liquid sample. The transport zone is characterized in that it comprises an array of elevated structures of a form, dimensions and with a spacing in between the elevated structures such that a capillary force-driven flow of the liquid sample from the loading zone through the separation zone is achieved. Such devices in a preferred embodiment can comprise a zone for a laser desorption/ionization-based mass separation and detection which is characterized by the presence of at least one metal component and/or at least one energy absorbing molecule (EAM) being capable for use as matrix material in matrix assisted laser desorption ionization mass spectrometry (MALDI-MS).

The present invention therefore also relates to the use of these devices in bioassays and preferably for in vitro diagnostic methods. A particularly preferred application is the use for such devices for in vitro diagnostic methods on body fluids such as blood, serum, plasma and/or urine with a particular focus on the detection of markers or proteomic patterns being indicative of diseases such as cancer.

Thus, a preferred embodiment relates to the analysis of blood drawn from a human or animal being and analysis of this blood sample by MALDI-MS after prior purification of the sample in accordance with a method and devices as claimed and described herein.

### DESCRIPTON OF THE FIGURES

FIG. 1 depicts different cross section forms of the elevated structures of the transport zone.

FIG. 2 depicts how elevated structures of the same form but with different spacing in between the structures can be arranged in the transport zone. The specific topography creates a capillary force driven flow. At the same time a filter effect along the arrow is established.

FIG. 3 shows a schematic outlay of a device in accordance with the present invention. The loading zone, transport zone and LDI detection zone are shown. The separation zone is formed by the surface modification and physical outlay of the transport zone.

FIG. 4 shows a schematic outlay of a device in accordance with the present invention. The loading zone, transport zone and LDI detection zone are shown. The separation zone is formed by the surface modification and physical outlay of the transport zone. The transport zone is divided into different flow paths. A different flow rate can be achieved within the different flow paths by different form, dimensions, spacing and distribution of the elevated structures within the different flow paths.

FIG. 5 shows a similar outlay as FIG. 3. Again there is loading zone, transport zone and LDI detection zone. One separation zone is formed by the surface modification and physical outlay of the transport zone. There is an additional separation or barrier zone which may be functionalized by an antibody or a chromatographic coating.

FIG. 6 shows a similar outlay as FIG. 4. There is loading zone, transport zone and LDI detection zone. One separation zone is formed by the surface modification and physical outlay of the transport zone. There is an additional separation zone which may be functionalized by an antibody or a chromatographic coating. The transport zone is divided into different flow paths. A different flow rate can be achieved within the different flow paths by different form, dimensions, spacing and distribution of the elevated structures within the different flow paths.

FIG. 7 shows a similar outlay as FIG. 5. Again there is loading zone, transport zone and LDI detection zone. One separation zone is formed by the surface modification and physical outlay of the transport zone. There are two or one additional separation zones which may be functionalized by e.g. an antibody coating, cation exchange, anion exchange or an IMAC resin.

FIG. 8 shows a similar outlay as FIG. 6. There is loading zone, transport zone and LDI detection zone. One separation zone is formed by the surface modification and physical outlay of the transport zone. There are two additional separation zones which may be functionalized by e.g. an antibody coating and an IMAC resin. The transport zone is divided into different flow paths. A different flow rate can be achieved within the different flow paths by different form, dimensions, spacing and distribution of the elevated structures within the different flow paths.

FIG. 9 shows a further embodiment. The loading zone (110) is connected to the transport zone which extends throughout the remaining parts of the device. One separation zone (120) is present in the transport zone as well as two LDI detection zones (130, 140). In this embodiment, the distant LDI zone (140) will give a mass spectrum similar to the proximate LDI zone (130), but without the component(s) removed in the separation zone (120).

### DETAILED DESCRIPTION OF THE INVENTION

As has been set out above, there is a continuing need for devices which allow the separation of biological samples in an easy to conduct manner and enable multiplex analysis of the separated sample by mass spectrometry.

The present invention provides devices and methods for solving this need. Before these aspects of the invention will be described in more detail, some general definitions are provided which apply throughout the description of the present invention.

As used in this specification and in the appended claims, the singular forms of “a”, and “an” also include the respective plurals unless the context clearly dictates otherwise. Thus, the term “an analyte” can include more than one analyte, namely two, three, four, five etc. analytes, as well as a pattern of analytes which together have decisive diagnostic properties.

The term “about” in the context of the present invention denotes an interval of accuracy that the person skilled in the art will understand to still ensure the technical effect of the feature in question. The term typically indicates a deviation from the indicated numerical value of +/−10% or preferably +/−5%.

The term “sample” means a volume of a liquid be it a solution, emulsion or suspension which one intends to use for a qualitative or quantitative determination of any of its properties such as the presence or absence of a component, the concentration of a component etc.

A sample may be a sample taken from an organism such as a human or animal being, from the biosphere such as a water or mud sample or from an industrial process fluid including process fluids of manufacturing processes of medicaments, food or feed, from the purification of drinking water or from effluent waste fluids. The sample may be directly subjected to qualitative or quantitative determination or after suitable pre-treatment such as homogenization, sonication, lysis, filtering, sedimentation, centrifugation, heat treatment, etc.

Typical samples in the context of the present invention are body fluids such as blood, plasma, serum, lymph, urine, saliva, semen, gastric fluid, sputum, tears, etc.

Other typical samples are environmental fluids such as surface water, ground water, sludge, etc.

Industrial samples include process fluids such as milk, whey, broth, nutrition solutions, cell culture medium, etc.

While the present invention is intended to be usable for all type of the aforementioned samples, samples of body fluids and whole blood samples constitute a preferred sample type.

The term “analyte” for the purpose of the present invention is used synonymous to the term “marker” and describes any substance that is present within a sample and the presence and/or amount of which is to be confirmed by LDI-based mass separation and detection methods.

The present invention in one embodiment provides a device for separating at least one analyte in a liquid sample comprising at least one substrate with:
at least one zone for loading a liquid sample;
at least one zone for transporting said liquid sample;
at least one zone for separating said at least one analyte from other components of said liquid sample; and
at least one zone for laser desorption ionization (LDI) mass spectrometry detection;
wherein said at least one transport zone comprises an array of elevated structures of a form, dimensions and spacing in between said elevated structures such that a capillary force-driven flow of said sample from said loading zone trough said separation zone to said LDI detection zone is achieved.

The device is thus characterized by the presence of a loading zone, a transport zone, a laser desorption ionization (LDI) detection zone and a separation zone. As will be set out below the separation zone can be located adjacent to and/or in the loading zone, the transport zone and/or the LDI detection zone.

The term “substrate” means the substance, carrier, surface, matrix or chip upon which the loading zone, transport zone, LDI detection zone and/or separation zone are arranged.

Thus, the term “substrate” describes a carrier structure on which the actual separation and qualitative and/or quantitative determination is performed. The substrate can be made from the same material as the loading, transport, separation and/or LDI detection zone and thus may be made from any of the below mentioned plastic materials. However, the substrate may also be made from another material than the materials that are used for producing the loading, transport, separation and/or LDI detection zone. Thus, if the aforementioned zones are made from e.g. silicon, the substrate in one embodiment can be made from a glass cover slide, from a metal, or from any other material that is compatible with the intended use of the device, namely the introduction into a mass spectrometer. Typical substrate materials are silicon, glass, quartz, ceramic, metal or plastic material. e. g. PMMA or Teflon.

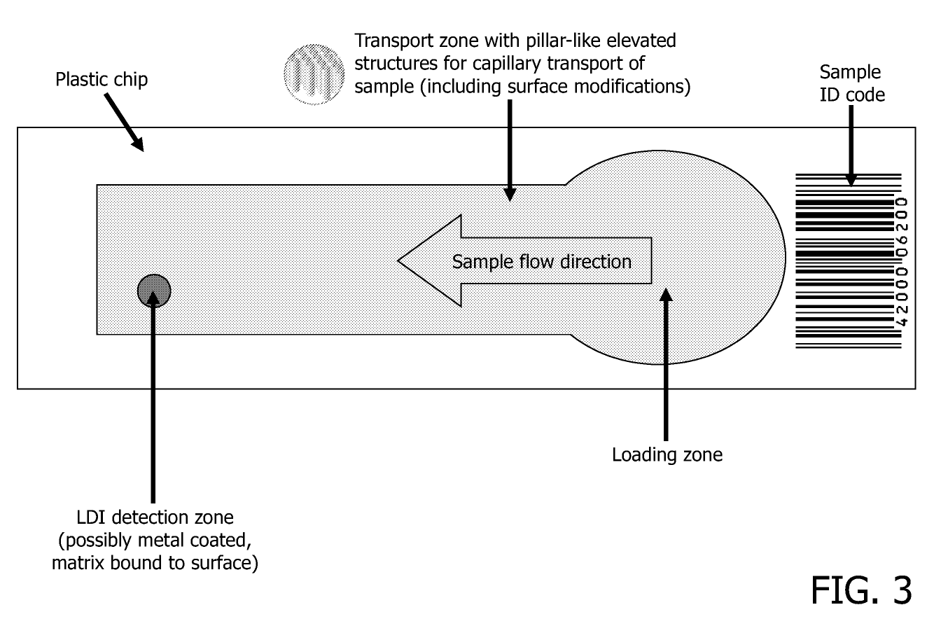

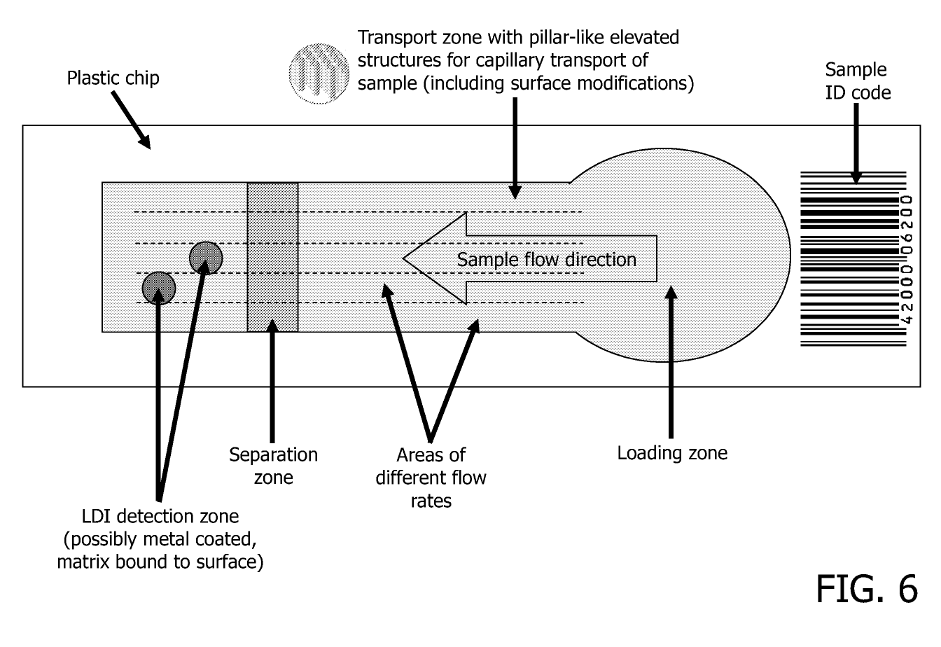

Typically the various zones (loading zone, transport zone, separation zone and/or LDI detection zone) will be built on a plastic substrate, which preferably is thermoplastic or a substrate having a plastic upper layer. The various zones need not be physically separated, as described in FIGS. 3 and 6. The substrate can in turn be coated or derivatized using techniques such as sputtering, evaporation, sol-gel coating, wafer deposition and the like to give e.g. a coating of silicon, metal or other materials. The substrates of the present invention can also be made of silicon substrates.

The terms “zone”, “area” and “site” as they are used in the context of this description, examples and claims define part of the flow path of a liquid sample on the aforementioned substrate.

The term “array” describes an ordered regular lay out of elevated structures on a surface.

The different types of zones as mentioned above will now be explained in more detail.

### Loading Zone

The loading zone is designed to receive the liquid sample. It thus can take any form that is suitable to accommodate the liquid sample. Such forms include a round form, an elliptical form, a rectangular form, etc. The loading zone may provide a recess or depression so that the liquid sample does not spill over the substrate. In any case the loading zone will be designed to allow a communication of the liquid sample from the loading zone to the transport zone and the other zones.

### Transport Zone

The transport zone comprises an array of elevated structures of a form, size and spacing in between said elevated structures such that a capillary force-driven flow of liquid sample components from the loading zone along the transport zone is achieved.

Thus, the present invention relates to devices which by way of their design of the transport zone allow for a passive flow (i.e. no outside force is applied) along the transport zone.

The elevated structures can take e.g. a pillar-like appearance and project substantially vertical from the plane of the substrate. They may therefore also be designated as pillars, columns or projections.

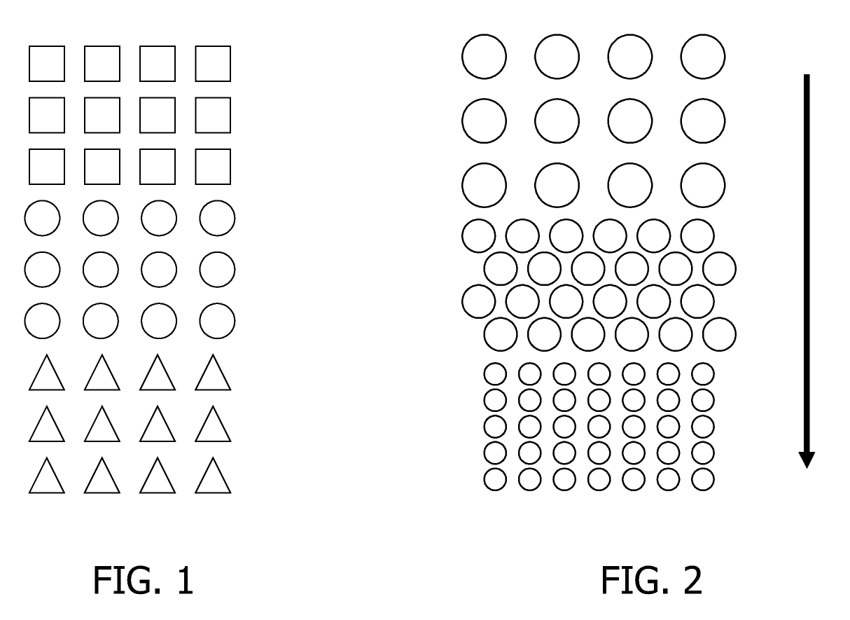

The elevated structures may take any form that is suitable for providing a capillary force-driven flow of sample components. They thus may be round, elliptic, rectangular, triangular, etc. Typical appearances of the elevated structures are depicted in FIG. 1.

The height of the elevated structures will typically be higher than approximately 1 μm and typically lower than approximately 1000 μm. In certain preferred embodiments, the height of the elevated structures will be higher than 5 μm and even more preferably higher than 20 μm.

The width of the elevated structures will typically be the height times a factor 0.5-1, e.g. 5-10 μm for a 10 μm high structure.

The elevated structures will for example be of submicrometer to several hundreds of micrometer size, typically 5-75 μm, with similar diameters and spacing, the aspect ratio of the pillars being typically >2.5.)

The spacing between the elevated structures will typically be in the range of approximately 0.1 to approximately 1000 μm. A preferred embodiment relates to devices wherein the spacing between the elevated structures is in the interval of 1 to 100 μm and more preferably in the interval of 1 to 50 μm.

The spacing between the elevated structures does not have to be the same in all directions even though such an arrangement could represent a preferred embodiment.

The spacing and/or distance between the elevated structures can be chosen by a skilled person who will base his choice depending on type of sample. Thus, the skilled person will be clearly aware that the different viscosities of different samples will pose different requirements on the form, dimensions and the spacing between the elevated structures for ensuring a capillary force-driven flow of the liquid sample along the transport zone.

For example, the spacing between pillars can be chosen from 5.8 to 6.0 μm allowing for a sphere with 5.7 μm diameter to fit in between them so that centrum spacing between the spheres is 10 μm if analytes smaller than 5.7 μm are to be transported by capillary force-driven flow.

The elevated structures can be designed to not only ensure a capillary force-driven flow but also to exhibit a preferred direction of flow. This can be achieved by using elevated structures of different cross-sectional form in different parts of the flow path, different spacing between the elevated structures in different parts of the flow path, different chemical or biochemical surface treatment of the elevated structures in different parts of the flow path or different height levels in different parts of the flow path.

Thus, the flow path of the transport zone may be subdivided into different zones wherein the elevated structures can have a different height, length, width, form and/or spacing between the elevated structures. If for example the elevated structures take the form of pillars, the pillars can be provided in one zone in close proximity in adjacent groups having different dimensions and spacing.

Depending on the form, the spacing etc., a person skilled in the art will be able to select a preferred flow direction by designing the pillars to provide an increasingly stronger capillary force. This typically will be achieved if the spacing in between the elevated structures will be reduced. Thus, one may start at the beginning of the transport zone with a pillar spacing of a approximately 100 μm which will be increasingly be narrowed down to approximately 10 μm. As the narrowing of spacing will lead to an increased capillary force, the liquid sample will be forced into the direction of the pillar-like structures with reduced spacing. Such an embodiment of the invention is schematically depicted in FIG. 2.

The person skilled in the art is, of course, aware that continuously decreasing the spacing between the elevated structures will also create a filter effect which can be used to separate some components of the liquid sample as will be explained below in the context of the separation zone.

For example, the device may use a first “dense region” in the transport zone in which the spacing in between the elevated structures is comparably small. Such a region will act as a sieve or fence preventing larger particles such as cells from passing along the transport zone. Next, there may be a region with elevated structures having relatively larger spacing between the elevated structures. This can serve to temporarily decrease the time for a liquid-solid phase interaction if it is for example desired that the sample is exposed to some surface bound moiety for a specified time in order for a particular reaction to proceed to reasonable completion. After this low velocity region, there may be provided an additional region of larger elevated structures having fairly narrow passages between them. The design and outlay of the elevated structure will thus have an impact on the separation as well as on the flow path of the liquid sample.

The flow path of the sample may also be influenced by functionalising part of the surface of the elevated structures. Thus it may be considered to attach or trap particles in between the elevated structures. These particles can be chosen among commercially available or custom-made particles such as micro- or nano-particles and may have a core of glass, metal or polymer or a combination of these and they may optionally carry on their surface chemical or biological moieties such as proteins, antibodies, amino acids, nucleic acids, carbohydrates, carboxylic moieties, amine moieties, etc.

The particles can be chemically or physically bound to the substrate or mechanically trapped within the pillar-like structures covered region by self-assembly. Depending on the affinity of the liquid sample for such functionalized surfaces of the elevated structures, the flow of the liquid sample may be directed in a certain direction.

In another embodiment the properties of the elevated structures like form, dimensions and/or spacing in combination with additionally functionalising the surface of part of the elevated structures can be used to form a gradient, i.e. a continuous change over part of the transport zone causing gradual retention, filtering and/or changing the flow rate of the sample.

The direction of flow, e.g. the prevention of undesired back flow of sample, can however not only be influenced by the design and outlay of the elevated structures as described above but also external influences chosen among heating, cooling, irradiation with visible and/or UV light, and/or the application of an electric current or a combination thereof acting on at least a part of the transport zone. The design of the elevated structures may again be used to support and enhance the effect of these external forces. For example, the height of the elevated structure may be reduced to increase heat-mediated vaporisation. Yes, perfectly correct. (But the device is meant to separate samples without external sources as the most important case.)

The transport zone can also comprise one, two or more flow paths each of which may for example be connected to a specific LDI detection area. Such a device would be suitable for performing multiple analyses in parallel with one single sample starting from one loading zone (multiplexing). In this case, each transport zone may for example comprise elevated structures of different form, dimensions and/or spacing between the elevated structures. Similarly, each flow path may be further functionalized by for example using different chemical coatings or biological molecules. The different flow paths of the transport zone can be separated for example by a wall which is higher than the elevated structures in order to prevent spill over and thus cross contamination between the different flow paths. The different flow paths can also be separated merely by the absence of elevated structures if the distance between the elevated structures is sufficiently large to avoid capillary force driven flow.

There are different possibilities of manufacturing the elevated structures on a substrate as mentioned above. These include silicon lithography, electro-plating, embossing, casting, injection moulding of e.g. PMMA, polycarbonate, polyoleofines such as Zeonor or Topas, and the corresponding carbon filled materials which are conductive. Other methods include dicing or DRIE etching of silicon (see below).

Typically the manufacturing process includes fabrication of a silicon master, electroplating of a nickel mould tool from the silicon master and replication of large volumes of polymer substrates by injection moulding from the mould tool just like it is done for e.g. a music CD. Thus, the silicon master is manufactured with the accuracy of the semiconductor industry and subsequently replicated with a production economy of the music CD business.

Manufacturing of such elevated structures could thus in its simplest form be done by direct curing of a photosensitive mono-or pre-polymer deposited on a substrate, employing a mask through which light is irradiated to initiate curing, and thereafter rinsing away the un-cured areas (thick film photo-resist process).

Another straightforward method is through replication of an original into a polymer. The original could be manufactured in silicon through a DRIE-process (Deep Reactive Ion Etch) where high aspect ratio structures could be produced. Other ways of producing such originals could for instance be through laser processing, electro discharge methods, Free Form Manufacturing (FFM), electrochemical or chemical etching, gas phase etching, mechanical processing, thick film photoresist processes or combinations thereof, of or on a substrate of, for instance, silicon, glass, quartz, ceramic, metal or plastic material as e. g. PMMA, polycarbonate, polyoleofines or Teflon.

One of the most straightforward methods of replication would be casting of a mono-or pre-polymer over an original with the desired negative shape. Other ways of producing the polymer replicas could involve injection molding or embossing of thermoplastics or thermoset materials.

If the original in some aspects are not withstanding the replication process, an intermediate replica in a suitable material (a stamper) could first be produced from the original. Examples of such stamper process could be used to first deposit a conducting layer on top of the original and thereafter through electroplating form a negative from the original. Certain plating materials such as Nickel are well suited to the repeated and non-destructive production of copies of the stamper. This gives the possibility to both change polarity from negative to positive as well as producing series of identical stampers for large volume production of replicas. Other examples of stamper manufacturing could be in a well-chosen polymer given the negative shape of the original in a casting, embossing or injection molding process. The same possibility of repeatedly and non-destructively making copies of the stamper could also be true for polymer stampers.

Polymers suitable for injection moulding of the elevated structures include e.g. polycarbonate and cyclic polyoleofines such as e.g. Zeonor and Topas.

The elevated structures according to the invention can be made in different ways. Some of the common methods are outlined above, but it is also possible to make the structures from separate parts which are assembled after e.g. pillar formation has taken place on a suitable substrate.

It is to be understood that the transport zone may not be necessarily physically distinct from the loading zone and/or LDI detection zone. Thus, the elevated structures of the transport zone may already present in the loading zone and they may also extend into the LDI detection zone.

It has already been set out above that the choice of the form, the dimensions and the spacing between the elevated structures of the transport zone can not only have an effect on the flow direction by providing capillary force-mediated flow of the sample but also on the separation of the liquid sample that is applied to the loading zone.

The principles that can be used to separate analytes within a liquid sample by the separation zone will now be put forward in more detail.

### Separation Zone

The separation zone relates to an area of the device along the flow path of the liquid sample in which separation of at least one analyte from other components of the sample is achieved.

For this purpose the separating zone may be positioned adjacent to and/or in the loading zone, the transport zone and/or the LDI detection zone.

The whole flow path of the liquid sample from the loading zone across the transport zone to the LDI detection area may thus be formed from elevated structures as described above and by way of design of the elevated structures at the same time be the complete separation zone.

However, the separation zone may also only be located in (part of) the loading zone, it may be located only in (part of) the LDI detection zone or it may be located only in (part of) the separation zone.

In yet another embodiment there may be various separation zones along the transport zone and further combinations of the arrangement of separation zones will be obvious to the person skilled in the art particularly in view of the below described preferred embodiments.

The separation zone may provide separation of analytes from other components of the liquid sample by physical, chemical or biological functionalities.

Separation by physical functionalities has already been partially described above in the context of the design of the transport zone. Thus, the elevated structures which provide the capillary force-driven flow of the liquid sample from the loading zone to the LDI detection area can also be used to separate analytes from a sample by e.g. filtering and retaining comparatively large particulate matter of the sample. This may be achieved by selection of the appropriate form, dimensions of and spacing between the elevated structures.

For example, barriers for particulate matter of the liquid sample may consist of elevated structures with a spacing in between the structures which prevents the transport of the particulate matter along the transport zone of the device. Thus, gentle separation of red blood cells from whole blood, i.e. separation of red blood cells without significant rupture of said cells can be achieved with a gradient of pillar-like structures where the pillar spacing decreases from about 7 μm to about 1 μm over the length of the separation zone. Other particulate matter includes but is not limited to cells, platelets, macrophages, bacteria, virus particles and homogenized solid tissue.

This makes also clear that the separation area for example may already be located in the form of the afore-described elevated structures right next to or in the loading zone so that any penetration of particulate matter of the liquid sample into the flow path or other separation zones which are further downstream is prevented.

The term “physical functionality” therefore comprises functionalities involved in reactions and interactions other than those that are mainly chemical or biological. Examples are the aforementioned elevated structures of different form, dimensions, spacing, surface topography, surface density, i.e. the number of elevated structures per unit area, wetting behaviour of the surface of said elevated structures or a combination thereof and/or other functionalities influencing the flow, retention, adhesion or rejection of components of the sample. Thus, a separation zone may be made from electrodes in order to separate components of the sample that are electrically charged.

It has already been mentioned above that a transport zone of a device in accordance with the invention may provide for different flow paths of e.g. different flow rates. Of course, since the different flow paths of different flow rates can be realized by elevated structures of different form, dimensions and spacing between the elevated structures, such different flow paths also will have different separation characteristics for a certain liquid sample. Thus by designing flow paths with elevated structures of different form, dimensions and/or spacing within a single device all of which originate from the same loading zone, it is possible to carry out numerous separation approaches in parallel on a single device from a single sample (multiplexing).

It is also possible to achieve a separation of analytes from other components of the sample using chemical functionalities. The term “chemical functionality” comprises any chemical compound or moiety necessary for conducting or facilitating separation of an analyte from a liquid sample. One group of chemical compounds that can be used for that purpose are for example coatings that exhibit a certain specific affinity or capability of binding or interacting with one or more components in the sample. Such components may for example be hydrophobic coatings which can be made from aliphatic hydrocarbons, specifically C₁-C₁₈ aliphatic hydrocarbons, or aromatic hydrocarbons comprising e.g. functional group such as phenyl groups. Such hydrophobic surfaces may be preferably used for analyzing salt-promoted interaction. Other materials that are useful for analyzing salt-promoted interactions include thiophilic interaction absorbance such as T-GEL® available from Pierce, Rockford, Ill. Other chemical functionalities include hydrophilic coatings such as metal oxides such as titanium oxide, silicon oxide, hydrophilic polymers such as dextran, linear or branched aliphatic polymers, polyethylenglycol, agarose, cellulose, heparin, poly-L-lysin and derivatives thereof, epoxides, detergents, biologic substances such as polymers, carbohydrates, macromolecules or combinations thereof, etc. Polymers may be derivatized to achieve high densities of e.g. carboxylic, ammonium or IMAC groups.

The separation zone can also be given a hydrophilic treatment before functionalization, e.g. by subjecting the substrate to an oxidative treatment, e.g. gas plasma treatment.

Chemical functionalities also include for example covering the elevated structures within a transport zone, loading zone and/or LDI detection zone with molecular moieties that allow separating certain components of the liquid sample on the basis of their charge. Similarly, such chemical functionalities may be deposited on substrate regions along the flow path of the sample which do not comprise elevated structures. In such a case it has to be made sure that the section is not of such dimensions that capillary-driven flow to the next transport/separation zone is impaired.

Thus, in one embodiment one may coat the elevated structures of a part of the transport zone with resins as they are typically used for cationic or anionic exchange chromatography. Similarly one may coat parts of the elevated structures of a transport zone, loading zone and/or LDI detection zone with a resin as it is commonly used in hydrophobic interaction chromatography.

The person skilled in the art is familiar with such resins and will be in a position to select the required chemical separation principle according to its needs. Anionic exchange matrices include matrices of secondary, tertiary or quarternary amines. One may also use the molecular entities of common anionic chromatography resins such as Q-Sepharose, DEAE-Sepharose as available from Amersham. The relevant moieties are in this case quaternary amines. In the case of cationic exchange chromatography one may use absorbance materials such as matrices of sulfate anions, matrices of carboxylate anions or phosphate anions.

Other chemical functionalities include coordinate covalent interaction absorbance materials as they are typically used for immobilized metal affinity capture (IMAC). In this context, one may consider to use nitrilotriacetic acid based surfaces in the separation zone. Other chemical modifications will be clear to the person skilled in the art.

In the following, chemical functionalities of a separation zone will be discussed with respect to the separation of red blood cells from blood which constitutes one of the preferred applications of the present invention. However, the person skilled in the art will understand that these principles also apply to other samples.

One group of chemical compounds, with particular relevance in the present invention, is compounds or components exhibiting specific affinity to, or capability of binding or interacting with, one or more components in a blood sample.

Red blood cell separating agents constitute an illustrative example. Such agents may be any substance capable of aggregating or binding red blood cells, such as lectins. Preferred agents are positively charged materials such as polycations, including e. g., poly-L-lysine hydrobromide; poly (dimethyl diallyl ammonium) chloride (Merquat TM-100, Merquat TM 280, Merquat TM 550); poly-L-arginine hydrochloride; poly-L- histidine; poly (4-vinylpyridine), poly (4-vinylpyridine) hydrochloride; poly (4- vinylpyridine) cross-linked, methylchloride quaternary salt; poly (4-vinylpyridine-co-styrene); poly (4-vinylpyridinium poly (hydrogen fluoride)); poly(4-vinylpyridinium-P-toluene sulfonate); poly (4-vinylpyridinium-tribromide); poly(4-vinylpyrrolidone-co-2- dimethylamino ethyl methacrylate); polyvinylpyrrolidone, cross-linked polyvinylpyrrolidone, poly(melamine-co-formaldehyde); partially methylated hexadimethrine bromide; poly(Glu, Lys) 1:4 hydrobromide; poly (Lys, Ala) 3:1 hydrobromide; poly (Lys, Ala) 2:1 hydrobromide; poly-L-lysine succinylated ; poly (Lys, Ala) 1:1 hydrobromide; and poly (Lys, Tip) 1:4 hydrobromide. One of the most preferred polycationic materials in this context is poly (dimethyl diallyl ammonium) chloride (Merquat TM-100).

The red blood cell separating agent may be used in any suitable amount in the separation zone. Depending on the design of the separation zone, it may thus be coated on the above-mentioned elevated structures or on the plane substrate.

Thus, by selecting a combination of a certain form, dimension and spacing of and between the elevated structures of the transport zone and applying a chemical functionality to an area of the transport zone it is for example possible that the sample flow is fine-tuned into a certain direction and that separation of certain analytes as well as removal of certain components of the sample is achieved at the same time. For example, the sample flow can be fine-tuned by adjusting the diameter, height, shape, cross-section, spacing, surface topography, surface patterns and number of elevated structures per unit area. Furthermore, the elevated structures may be surface-coated to ensure a certain wetting behaviour of the surface of the elevated structure.

In addition, another part of the transport zone or the whole device may be coated with a hydrophilic coating by for example subjecting this part of the elevated structures to an oxidative treatment namely gas plasma treatment. It may also be coated with a hydrophilic substance such as silicon oxide, or hydrophilic polymers such as dextran, polyethylenglycol, heparin and derivatives thereof, detergents etc. Using such specific combinations one will be able to direct the flow into a certain direction and to separate certain components from the sample at the same time.

If additionally distinct flow paths are provided within the transport zone of the device by e.g. including separating walls or pillar-free areas between the flow paths and if the flow paths are coated with different chemical functionalities, a multiplex analysis of the same sample for different properties will be possible.

Alternatively to or in addition to the physical and/or chemical functionalities, a separation zone may be characterized by a biological functionality.

The term “biological functionality” comprises all biological interactions between a component in a sample and a reagent on and/or in the separation zone such as catalysis, binding, internationalization, activation or other biospecific binding interactions. Suitable typical reagents that can be used for biological functionalities include but are not limited to antibodies, antibody fragments and derivatives thereof, single chain antibodies, protein A, protein G, streptavidin, carbohydrates, lectins, DNA, RNA, aptamers, modified nucleic acids, receptors, ligands, small molecule inhibitors, etc.

For example, the elevated structures of a transport zone, loading zone and/or LDI detection zone or a planar region of the substrate may be modified to carry molecules chosen among polyclonal antibodies, monoclonal antibodies, amino acids, nucleic acids, carbohydrates, carboxylic moieties, etc. One example of a lectin is concanavalin A which can be used to bind glycoproteins in a sample.

The person skilled in the art is of course also aware that separate separation techniques can be applied within different areas of a transport zone, loading zone and/or LDI detection zone. Thus, the elevated structures of the transport zone may e.g. in one region be arranged such that they provide a filtering function for e.g. red blood cells by selecting the appropriate form, dimensions and the spacing in between the elevated structures as mentioned above. In a second region, the elevated structures of a transport zone may be modified to provide a separation zone based on a chemical functionality by for example coating the elevated structures with an IMAC resin. In a third area, the elevated structures of the transport zone may be coated with an antibody that is specific for a protein of interest.

If a blood sample is positioned in the loading zone, the red blood cells will be filtered out first by capillary force-generated lateral transport. In the second step components with affinity for the specific IMAC resin are retained if they for example are known to be detrimental for further analysis. In a later step, proteins can then be immobilized by antibodies. If as will be shown below, the LDI detection zone will also be present in that separation zone, one can detect the presence and/or amount of the protein bound to the antibody without any significant manipulation steps during handling of the liquid sample.

Thus, the person skilled in the art will be clearly aware that different separation principles such as hydrophobic coatings, hydrophilic coatings, ion exchange coatings or principles such as IMAC, biological functionalities such as nucleic acid probes, antibodies, receptors, etc. can be combined within different areas of the transport zone, loading zone and/or LDI detection zone to ensure significant separation of a liquid sample without any outside influence.

The movement of the liquid sample through the different separation zones will be provided by the capillary force that is created by the size, dimensions and spacing in between the elevated structures of the transport zone. As above, it is envisaged that a single device may comprise different lanes of transport zones which are separated by e.g. walls. Each lane may contain a flow path of different separation principle. Thus, the various lanes will allow a multiplex analysis of the same liquid sample without the necessity of adding washing buffers, or automated pipetting devices. If each lane further comprises different separation principles, the degree of multiplex analysis can be even further increased. Optionally, the device can be designed for and subjected to buffer addition or a similar wash step after sample addition.

### Laser Desorption Ionization Detection Zone

As mentioned above, it is a characteristic feature of the devices of the present invention that they comprise at least one zone for detection by a laser desorption ionization. The requirements of a spot in order to ensure detection of an analyte by laser desorption ionization based mechanisms such as mass spectrometry are well known to the person skilled in the art.

The zone for LDI detection comprises at least one metal and/or at least one energy absorbing molecule (EAM) being capable for use as matrix material in matrix assisted laser desorption ionization mass spectrometry (MALDI-MS) and/or at least one calibrant.

The person skilled in the art will thus be clearly aware that the quality in mass spectrometer analysis may be increased by using an LDI detection spot comprising a metal component such as gold and/or silver. Other suitable metals or alloys include platin, palladium, chromium, titanium and copper with e.g. adhesion layer of chromium and/or titanium.

Such metals may be deposited in an LDI detection area by sputtering metals such as gold on the elevated structures of a transport zone or on a plane region of the substrate. Thus, as for the separation zone, the LDI detection zone may be located adjacent to and/or in the transport zone and it may coincide with separation zone(s) meaning that the LDI detection zone can also comprise elevated structures of the afore-described type.

A metal will allow for charge transfer during desorption/ionization in the mass spectrometer analysis and thus will improve the quality of the overall analysis.

In addition or alternatively to using metals in the LDI detection zone, the LDI detection zone is characterized by the presence of a energy absorbing molecule as it is suitable for matrix associated laser desorption ionization mass spectrometry (MALDI-MS).

At least part of the LDI detection zone may therefore be prepared with a MALDI-MS matrix substance attached. Such matrix substances include e.g. alpha-cyano-4-hydroxycinnamic acid (CHCA), 3,5-dimethoxy-4-hydroxycinnamic acid (SPA) or 2,5-dihydroxybenzoic acid (DHB). Other matrix substances may be 4-hydroxypicolinic acid, tartaric acid or glycerine.

These matrix materials may be deposited in the LDI spot by common techniques. The person skilled in the art is well familiar with such techniques and is also aware that other polymeric materials which may be used for MALDI matrix purposes. Reference is made in this context to US 2003/0207460 A1 which mentions numerous monomers and polymers as EAM matrix materials that are particularly suitable to be deposited in an LDI detection zone before the analyte to be detected co-crystallizes in the matrix. For example, the co-polymerization of alpha-cyano-4-methacryloxy-cinnamic acid and octadecyl methacrylate prior to depositing the analyte in a certain spot is one suitable matrix material in the context of the present invention. Further examples will be obvious to the person skilled in the art. Some examples are derivatives of benzoic acid, cinnamic acid, and related aromatic compounds, e.g. 2,5-dihydroxybenzoic acid (2,5-DHB or gentisic acid), a-cyano-4-hydroxy cinnamic acid (CHCA), 3,5-dimethoxy-4-hydroxy cinnamic acid (sinapic acid, sinapinic acid or SPA), nicotinic acid, picolinic acid, trans-3-methoxy-4-hydroxy cinnamic acid (ferulic acid) 2-(4-hydroxyphenylazo)-benzoic acid (HABA), 6-aza-2-thiothymine (ATT), 3-HPA, succinic acid, glycerol, 2,4,6-trihydroxy acetophenone, 3-hydroxypico linic acid, 3-aminoquino line, 1,8,9-trihydroxy-anthracene (dithranol), the laser dye coumarin 120, substituted pyrimidines, pyridines, and anilines, e.g. para-nitroaniline.

The matrix materials may be covalently or non-covalently attached to the substrate and/or the elevated structures that can be present within an LDI detection zone.

In an alternative embodiment the LDI detection zone is defined by the presence of a calibrant, i.e. a calibration standard. Typically, one may use any type of molecule that is suitable as reference and calibration standard in MALDI-MS. Specific examples of biological calibration standards are set out below.

In a preferred embodiment the LDI detection zone may additionally provide for a calibration standard that has been deposited in a certain area together with (or without) the matrix material(s). Thus, one can deposit a calibration standard in the LDI detection zone. This may be covalently or non-covalently attached. If an analyte reaches the LDI detection zone and if MALDI is performed, the calibration standard will be ionized and desorbed together with the analyte so that an analysis of the analyte spectrum will be possible based on the spectrum of the known calibration standard. Alternatively, there may be a separate LDI zone, not adjacent to a transport or separation area, with calibration standard(s) attached. LDI is then performed from LDI zones with sample constituents as well as from the LDI zone with calibrant(s). Typical calibration standards that can be used are depicted in table 1 below:

### Table 1: Calibration Standards

It has been mentioned above that exact control over the sample flow in a region with elevated structures can achieved by tailoring the form, dimensions and the spacing between the elevated structures and e.g. surface modification. By fine-tuning the flow rate of the sample in such region with elevated structures, crystallization rate in a LDI detection zone can also be controlled.

As is obvious from the above-mentioned statements, the person skilled in the art is clearly aware that the LDI detection area may be located adjacent to and/or in the transport and/or separation zone.

If for example an antibody is deposited on the elevated structures of a part of the transport zone and thereby creates a separation zone, this antibody may have the function to fish out components to be analyzed by mass spectrometry, i.e. the antibody separation zone is also the LDI detection zone. Alternatively, the antibody may have the function to fish out components to be removed before an analysis and in this latter case, the separation zone may not coincide with the LDI detection zone which would then be located downstream from the antibody separation zone.

For example, some clinical researches in the field of MS-based diagnostics remove albumin as part of sample preparation before MS analysis because it is present in blood serum in high enough concentration to dominate the mass spectrum whereas others capture albumin and perform MS because albumin carries diagnostically relevant peptides on itself.

There are various combinations and variations possible to the aforementioned use of a metal component and/or a MALDI matrix component in the LDI detection area. Thus, in an exemplary process, one starts with sputtering a thin gold layer onto the elevated structures of the transport zone in order to create an LDI detection area. Subsequently an alkanethiol compound with a functional group is allowed to form a self-assembled monolayer on the surface. The functional group is then used for further chemical modification with e.g. dextran or polyethyleneglycol. This modification creates a metal-based LDI detection spot together with a chemical functionality for certain sample components.

In addition or after sputtering a thin gold layer on the elevated structures in order to create an LDI detection area, one can prepare a thin film of a MALDI matrix substance as mentioned above. Alternatively, the LDI detection area is created by depositing a MALDI matrix only. Subsequently, an alkanethiol compound with a functional group is allowed to form a self-assembled monolayer on the surface. The functional group is then used for further chemical modification with e.g. dextran or polyethyleneglycol.

The present invention is thus characterized in providing a device which on a substrate contains at least one loading zone for a liquid sample, at least one transportation zone and at least one LDI detection zone. The flow of the liquid sample from the loading zone to the LDI detection zone by the transport zone is mediated by elevated structures with a shape, dimensions and spacing in between the elevated structure to ensure a capillary force-driven passive flow of the liquid sample. The flow velocity and flow direction can be chosen by amending the form, the dimensions and/or the spacing in between the elevated structures.

In addition, the devices in accordance with the present invention include a separation zone which may rely on physical, chemical and biological functionalities to achieve either isolation of a distinctive analyte within the liquid sample or removal of certain components within the liquid sample. The person skilled in the art will be aware that a distinction between chemical, biological and physical functionalities may not always be possible and that an interaction such as an interaction between a component in a sample and a reagent on the substrate may involve both chemical, physical and biological elements. Nevertheless, physical functionalities will be mainly mediated also by the shape, dimensions and/or spacing in between the elevated structures that may be found in the transport zone, the loading zone and/or the LDI detection areas. The parameters of the elevated structures will thus form physical constraints such as filtering barriers or fences that can remove for example particulate matter from the liquid sample. Chemical and biological functionalities relate to the modification of the elevated structures in any of the loading zone, the transport zone and/or the LDI detection zone or of parts of any of the loading zone, the transport zone and/or the LDI detection zone which do not comprise such elevated structures to either allow isolation of a desired analyte or removal of unwanted other components of the sample. Of course, one may use different combinations of physical, biological and chemical functionalities and thereby create a device which allows to apply one single sample and subsequent multiplex analysis thereof.

In the following some of the preferred embodiments will be described in more detail.

FIG. 3 depicts one embodiment of the present invention. It consists of a loading zone which may also be designated as a sample application area. This sample application area is in intimate contact with the transport zone that consists of a pillar area with the pillars being designed to ensure capillary transport of sample. The pillars are schematically depicted in FIG. 3.

The liquid sample is transported through the transport zone by the capillary force generated by the pillar structure to an LDI detection zone. This LDI detection zone may comprise the same pillar-like structures as the transport zone, have shorter pillar-like structures or may be substantially planar. The LDI detection zone may be metal coated and/or it may have a MALDI matrix bound to its surface with or without a calibration standard. In addition the device may include an identification code (ID code) for sample tracking purposes.

If a liquid sample is applied to the loading zone the liquid sample will be passively transported by way of capillary action to the LDI detection zone. Once it has reached the LDI detection zone, the sample can be allowed to evaporate and thus to co-crystallize with the matrix material that has been for example deposited in the LDI detection zone and the whole device can then be inserted into a MALDI mass spectrometer.

Depending on the size, on the form, dimensions and spacing in between the pillar-like structures and the nature of the sample, the transport zone by itself may already allow for a separation by retaining particulate matter or larger structures such as for example red blood cells in the case of blood being the sample.

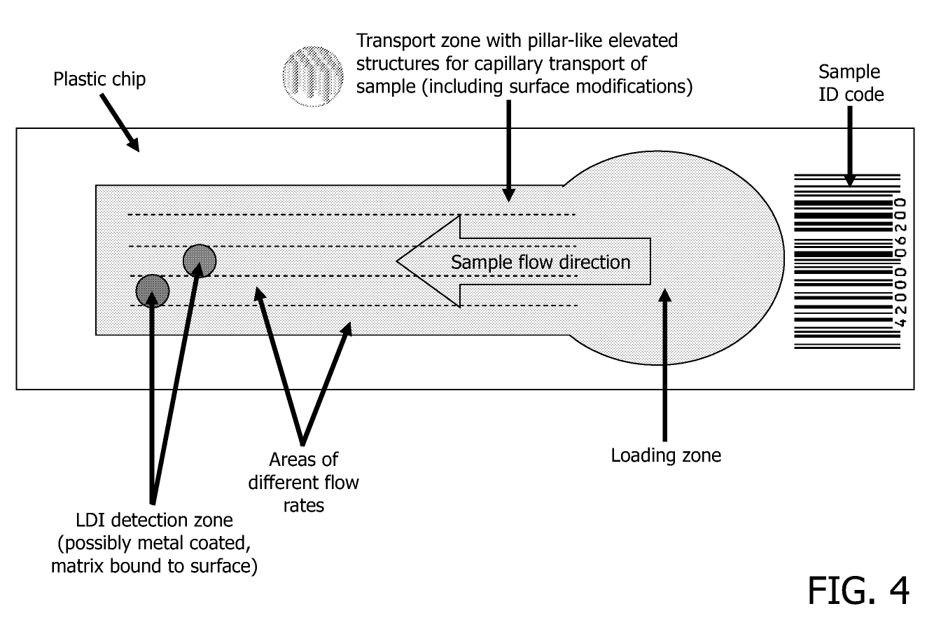

FIG. 4 shows a further embodiment of the present invention. In comparison to the device depicted in FIG. 3, the transport area is divided into five different sub-zones which may be separated by a thin wall or a pillar-free area preventing liquid overspill from one lane into the other. Each lane may comprise elevated structures of different form, length, width and height and with a different spacing in between the structures. Thus, each lane may have a different flow rate. Of course, as a consequence of the different density of the different elevated structure, such lanes will also provide five different separation areas which may be used to filtrate out particles of different size from the liquid sample.

In addition to the different form, dimensions and spacing in between the elevated structures, the lanes may be additionally functionalized by chemical and/or biological modification as described above. In this way the device allows a separation of the liquid sample according to different principles in parallel. As the liquid sample is added to the same loading zone, liquid can penetrate into the five different lanes directly and no automated pipetting means are not necessary. Further, the device in this aspect can be used to purify the liquid sample according to different principles without the need of using for example washing buffers etc.

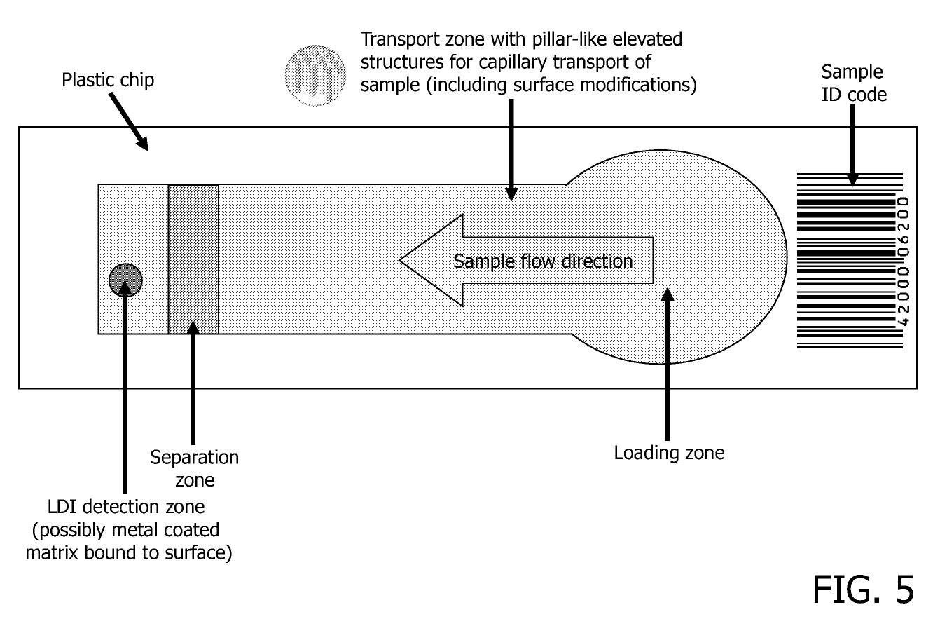

In FIG. 5 yet another embodiment is shown. Here a separation area is located in the transport zone in close proximity to the LDI detection zone. While the elevated structural elements of the transport area may of course also contribute to physical separation of a liquid probe, the separation area may provide separation in a distinct area of the transport zone. Thus, the separation area indicated may comprise elevated structure of higher density than the remaining part of the transport zone thereby creating a further filtering barrier. Additionally or alternatively the separation zone may be coated with e.g. an anionic resin or an antibody. Depending on the functionalities of the separation zone certain types of molecules may be retained within the separation area. If, for example, the separation area comprises a strong anionic exchange resin, positively charged polypeptides of the liquid sample may penetrate further to the LDI detection zone. In this embodiment of the invention the unwanted species of negatively charged proteins will therefore be retained within the separation zone. If, on the other side, it is the goal to detect negatively charged proteins in a liquid sample the LDI detection zone may be moved into the separation zone or vice versa.

FIG. 6 shows a combination of FIG. 4 and FIG. 5. Thus, the device comprises numerous flow paths which depending on their type of functionalities may provide different physical separation barriers and additionally provide affinity surfaces for chemical or biological interactions.

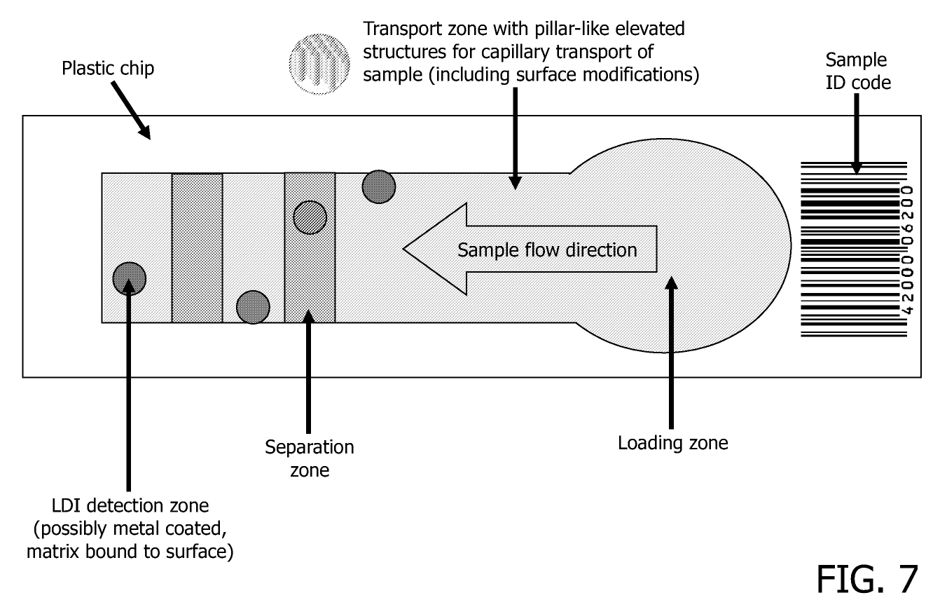

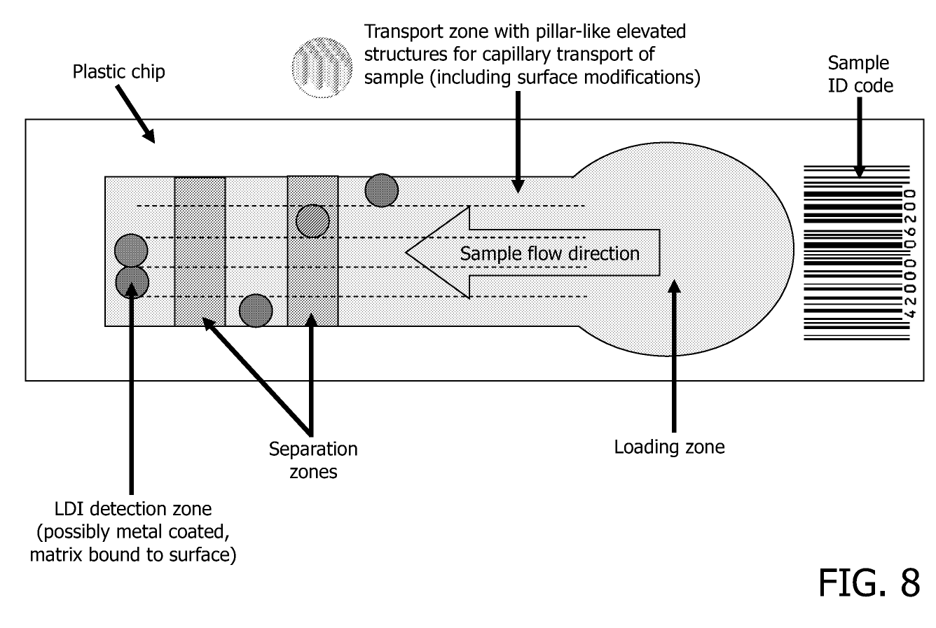

FIG. 7 is yet another embodiment of the present invention as is FIG. 8 both of which depict further elaborations of the aforementioned principles. Thus, again a liquid sample is transported by way of capillary force as provided by the elevated structures along the transport zone to LDI detection areas. The transport zone may comprise a separation zone of different principles such as for example a polymeric coating or an antibody coating. Depending on whether the analytes to be detected are retained in the separation area or pass through the separation area, the LDI detection zones may coincide with the separation area or they may be located downstream or upstream thereof FIG. 8 shows how parallel analysis can be further increased by introducing different flow paths.

It is understood that the aforementioned described examples and figures are not to be construed as limiting. The person skilled in the art will clearly be able to envisage further modifications of the principles laid out herein.

The present invention in another aspect also relates to methods for determining the presence and/or amount of at least one analyte in a sample comprising the steps of:
a) providing a device for separating at least one analyte in a liquid sample comprising at least one substrate with:
   at least one zone for loading a liquid sample;
   at least one zone for transporting said liquid sample; and
   at least one zone for separating said at least one analyte from other components of said liquid sample;
wherein said at least one transport zone comprises an array of elevated structures of a form, dimensions and spacing in between said elevated structures such that a capillary force-driven flow of said sample from said loading zone trough said separation zone is achieved;
b) loading a sample onto the loading zone of said device of step a);
c) separating said at least one analyte from other components of a said sample using said device of a);
d) determining the presence and/or amount of said at least one analyte by LDI-based methods such as MALDI-MS.

It is understood that the aforementioned principles as regards the design of the loading zone, the transport zone and the separation zone equally apply for the devices as used in the method of determining the presence and/or amount of an analyte in a sample.

It is also to be understood that if an embodiment of the device as preferred, this also applies to the devices when they are used in a method of determining the presence and/or amount of at least one analyte in a sample.

Thus, the transport zone may again be characterized in that elevated structures of a form, dimensions and spacing in between the structures are used in order to ensure that a capillary force-driven flow of the sample occurs from the loading zone into a certain direction passively.

However, for the purposes of determining the presence and/or amount of an analyte in sample, the devices do not necessarily have to comprise a designated pre-established LDI detection zone in the sense that this zone comprises a metal component and/or an EAM molecule being suitable for MALDI-MS and/or a calibrant. Thus, the device may be inserted into a mass spectrometer as such in order to carry out the analysis.

One may therefore use a device as described above without a designated pre-established LDI detection zone and apply a liquid sample to the device. The liquid sample will then be transported through the transport zone by way of the capillary force as generated by the elevated structures.

The transport zone by itself will ensure a certain flow path and at the same time may already provide for physical separation in view of the form, dimensions and spacing of the elevated structures. If, in addition, the elevated structures or other parts of the substrate are chemically or biologically functionalized as described above, movement of analytes into certain directions and specificity of sample separation can be increased.

The device may of course also comprise a separation zone as described above and the separation zone may be adjacent to and/or located in the loading zone and/or the transport zone. As described above, the separation zone may coincide completely with the loading and/or transport zone or may only form part thereof.

Thus, the separation zone may also be made of the aforementioned elevated structures and it may be in addition be functionalized by chemical or biological modification in order to provide different separation principles.

Of course, the device may also provide different flow paths and different separation zones of various separation principles in order to allow in parallel investigation of the same sample with respect to different analytes.

Once the sample has passed through the loading, transport and separation zones one may then preferably add a matrix material as being suitable for MALDI-MS at locations of interest and subsequently introduce the device into a mass spectrometer for the qualitative and/or quantitative determination of the presence of an analyte in the sample.

Similarly, one may sputter for example certain metals such as gold and silver into areas of interest. The person skilled in the art will of course also consider to use both metal and matrix materials being suitable for MALDI-MS simultaneously.

It may also be envisaged to add the MALDI-MS matrix material in a liquid form to the liquid sample and let it transport with the sample. Subsequently, the device may be subjected to evaporation and then MALDI-MS may be performed in these areas. The person skilled in the art will be clearly aware that calibration standards may be co-administered or pre-applied as described above.

While the method for determining the presence and/or amount of a certain component in a sample can be performed with a device that does not comprise a pre-established LDI detection zone, the use of such devices as mentioned above that comprise such pre-established LDI detection zone(s) can be preferred. In this instance, the LDI detection zone will comprise a metal component and/or matrix component being suitable for MALDI-MS and/or a calibrant as has been described above.

In one preferred embodiment multiple reagents, buffers, etc can be serially added to a flow path.

The present invention further relates to the use of a device comprising at least one substrate with:
at least zone for loading a liquid sample;
at least one zone for transporting said liquid sample; and
at least one zone for separating said at least one analyte from other components of said liquid sample;
wherein said at least one transport zone comprises an array of elevated structures of a form, dimensions and spacing in between said elevated structures such that a capillary force-driven flow of said sample from said loading zone trough said separation zone is achieved;

for separating at least one analyte in a liquid sample and subsequent determination of the presence and/or amount of said at least one analyte by MALDI-MS.

It is understood by the skilled person that all of the above modifications that have been described in the context of devices as regards the design of the loading zone, the transport zone, the separation zone and the pre-established LDI detection zone equally apply.

The present devices and methods can be advantageously used for e.g. in vitro diagnostic purposes. Some of the preferred embodiments relate to in vitro diagnostic analysis of body fluids such as urine, blood, blood plasma, semen, etc. for biological markers. The devices and methods as described above may however also be used for other diagnostic or analytical purposes on samples such as environmental samples, wastewater, etc.

The present invention therefore in one embodiment relates to the use of the above-described devices and methods in the context of in vitro diagnostic methods for separating at least one analyte of a liquid sample and subsequent determination of the presence and/or amount of said at least one analyte by MALDI-MS.

Examples of diagnostic determinations to that purpose include but are not limited to detection and staging of diseases. The diagnostic discriminator may be a marker, a combination of several markers, or e.g. a proteomic pattern. Diseases of potential interest include a variety of cancers (e.g. prostate, lung, colon, breast, ovarian cancer, non-small cell cancer, head and neck cancer, lymphomas etc.), cardiac and neurological diseases such as multiple sclerosis, Alzheimer disease, and infection diseases (e.g. sepsis). One blood sample could be screened for a number of different disease states at once using the inventive methods and devices.

In the context of these tests, one may use the devices and methods of the invention to detect common disease markers for e.g. oncologic diseases (PSA, telomerase for prostate cancer, CA-125 for ovarial cancer), chronic metabolic disorders, such as blood glucose, blood ketones, urine glucose (diabetes), blood cholesterol (atherosclerosis, obesitas, etc); markers of other specific diseases, e.g. acute diseases, such as coronary infarct markers (e.g. troponin-T), markers of thyroid function (e.g. determination of thyroid stimulating hormone (TSH)), markers of bacterial or viral infections (sepsis vs. SIRS, detection of specific viral antibodies); etc.

Another important field of diagnostic determinations relate to pregnancy and fertility, e.g. pregnancy tests (determination of i.a. human chorionic gonadotropin (hCG)), ovulation tests (determination of i.a. luteneizing hormone (LH)), fertility tests (determination of i.a. follicle-stimulating hormone (FSH)) etc.

Equally important to detection of single markers, like the ones listed above, is the detection and analysis of specific disease or disease stage discriminating peptide or protein patterns, as described by e.g. Adam et al. (Cancer Research (2002), 62, 3609-3614), by Petricoin et al. (Urol. Oncol. (2004), 22, 322-328) and by Liotta et al. (Nature (2003), 425). Such patterns can be used for sensitive and selective diagnosis in a wide variety of disease areas, such as those listed above.

Follow-up therapy is a related application field, including e.g. dose monitoring of chemotherapies, patient radiation response, metastatic behavior, host response to sepsis, cardiac failure, and infarct extent.

Research and development activities like proteomics, proteomic pattern discovery and analysis, biomarker or target discovery for e.g. imaging or therapy, and drug discovery and development form other interesting application areas of the present invention.

Yet another important field is that of drug tests, for easy and rapid detection of drugs and drug metabolites indicating drug abuse; such as the determination of specific drugs and drug metabolites (e.g. THC) in urine samples etc.

Particularly preferred is the use of such devices and methods in the context of in vitro diagnostic tests for determining the presence and/or amount of one of the aforementioned markers.

However, the person skilled in the art will also be clearly aware that the devices and methods can also be used in a lot of other applications such as for detecting toxins in waste water or industrial process fluids.

If for example the quality of food is to be controlled, the sample may be a raw material from the processing chain of milk. The sample may also be homogenized meat at the slaughterhouse or flower at the mill. The characteristics of the sample are then measured using MALDI-MS on a device and/or with a method in accordance with the invention.

In the context of industrial processes, it is to be considered that many of such processes involve complex liquids that have to be monitored over a period of days or weeks. Such processes include beer making, production of recombinant fine pharmaceuticals by fermentation and/or use of cell culture and production of enzymes for washing powders. Again, the liquids of such processes can be controlled by the devices and methods in accordance with the invention.

Some of the advantages of the present invention will be illustrated in the following with respect to the preferred application of in vitro diagnostic tests. The person skilled in the art will nevertheless understand that such advantages also apply to other applications as those mentioned above.

One of the advantages of the present invention is the use of devices which comprise a transport and separation zone comprising the aforementioned elevated structures and which allow SELDI/MALDI-MS multiplexing. The prior art discloses that SELDI is performed on one chromatographic surface for a specific selectivity condition. However, the present invention allows for an increase in efficiency not only because the sample is drawn over the specificity providing surfaces by capillary forces but also because a single sample preparation can be simultaneously subjected to numerous chromatographic alternatives without a substantial need of separate sample pre-treatment or automation.

This decreases variability of sample preparation because fewer steps of sample preparations are necessary. In turn, this decreased variability of sample preparation increases the specificity and accuracy of the SELDI/MALDI-MS measurement which is one of the decisive factors as far as diagnostic applications are concerned.

However, the present invention also allows increasing the level of multiplex analysis within one device by different separation principles. Thus, multiplexing can be achieved not only by incorporating more than one flow path in the transport zone of the device, but also by incorporating more than one LDI area in one and the same flow path.

For example, a whole blood sample can be separated with a separation zone which binds/stops the red blood cells and further downstream with one separation zone binding albumin. Four LDI detection zones can be incorporated along such a flow path. One may be located in the red blood cell binding/stopping zone (for MALDI-MS analysis of red blood cells), one in between the two separation zones, one in the albumin separation zone (for MALDI-MS analysis of peptides being associated with albumin) and one downstream of the albumin separation zone for analysis of albumin-depleted plasma.

The advantages of the present devices and methods also include high precision, giving well-defined flow and binding characteristics, low cost and simplicity. For example, there is no need for a lid, external pumps or electrical contacts to drive the flow even though such measures may be present in further embodiments of the invention. Washing steps are also not mandatory.

Further, the present devices are easy to manufacture as injection-moulded microstructures are excellently suited for sample preparation and MALDI-MS.

Besides these aspects certain disadvantages of common SELDI and MALDI technologies are overcome. As already set out, most of the problems of classical SELDI and MALDI-MS technology are related to sample handling and preparation, automation issues and the chromatographic platform. As the prior art approaches either require the separate provision of different chromatographic surfaces or the later addition of matrix material and calibrants, the present invention provides for certain advantages. The variability originating from matrix addition to each sample spot can be mitigated by incorporation of matrix material on pre-established LDI detection zones of the device in accordance with the invention resulting in more standardized sample crystallization with matrix.

Other advantages comprise the daily handling of the devices. The here suggested devices allow for simple mailing and storage of samples.

In case that several different chromatographic surfaces are needed in SELDIs platforms of the prior art, separate aliquots of the sample have to be prepared and disposed on each surface type. All sample preparation is performed usually close to the detection unit and requires a wet-chemistry lab. Using the inventive devices and methods, no bio-processor unit which usually requires the wet-chemistry surrounding is needed for device preparation.

By simplifying the sample preparation and removing many of the preparatory steps such as buffer exchange, a more controlled and less noisy sample preparation can be obtained.

Further, the suggested device is a low-cost disposable part. The present invention will now be illustrated further by hypothetical examples.

### Manufacturing Example for Device

Manufacture an original with appropriate technology e.g. thick film resist processing with SU-8, a positive epoxy based resin or silicone etching with DRIE Bosch process.
Transfer the original to a mould in a rigid material e.g. metal through casting with carbon or glass filled epoxies or electroplating of e.g. copper or nickel.
Mount the mould in an injection moulding apparatus as one side in a mould cavity.
Fill the mould cavity with melted thermoplastic polymer at high temperature e.g. 300° C. for Polycarbonate with a mould temperature of approximately 70° C. at a pressure of 200 Bar.
Remove the part from the mould after cooling appropriate time in order for the material of chip to come below Glass Transition temperature (e.g. PC 100 C).
Modify the surface with a conductive metal such as gold and chemical/biochemical functional coating(s).

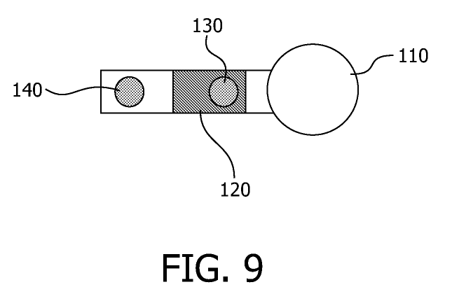

FIG. 9 discloses a device in accordance with the invention. The device has a sample loading zone (110), one flow path which is created by a transport zone consisting of elevated pillar-like structures (120). This transport zone coincides with the separation zone as it comprises an antibody coating on the elevated structures. The antibodies specifically bind serum albumin preventing it from propagating further along the device.

The device further comprises two LDI detection zones (130) and (140). It is noteworthy that the whole device is comprised of the already mentioned elevated structures so that a liquid sample that will be transported through the separation zone (120) will be further transported to the second LDI detection zone (140). The LDI detection zone (130) which is positioned within the separation zone (120) is also covered with antibodies. According to the design of the device, the liquid sample that reaches the second LDI detection zone (140) will have reduced amounts of serum albumin. In contrast, the LDI detection zone (130) will contain mainly serum albumin which is captured by the antibody present on and between the elevated structures.

In order to analyze a blood sample one will in a first step apply 20 μl of blood serum on the sample loading zone of the device. The device will then be incubated horizontally for five minutes at room temperature. The LDI detection zones will either have a SPA MALDI matrix already disposed or one will add 1 μl of saturated SPA matrix solution to the LDI zones. Subsequently the device will be inserted into a mass spectrometer and spectra for each LDI area will be obtained by MALDI-MS.

The invention has been described above with respect to some of its preferred embodiments. However, this is not to be construed in any limiting way. The person skilled in the art will be clearly in a position to envisage further modifications of the principles that underlie the above-described invention.

1. A device for separating at least one analyte in a liquid sample comprising at least one substrate with:
at least one zone for loading a liquid sample;
at least one zone for transporting said liquid sample;
at least one zone for separating said at least one analyte from other components of said liquid sample; and
at least one zone for laser desorption ionization (LDI) mass spectrometry detection;
wherein said at least one transport zone comprises an array of elevated structures of a form, dimensions and/or spacing in between said elevated structures such that a capillary force-driven flow of said sample from said loading zone trough said separation zone to said LDI detection zone is achieved.

2. Device according to claim 1,
wherein said elevated structures have pillar-like forms with the spacing between said pillar-structures being in the range of approximately 0.1 to 1000 μm, preferably in the range of approximately 0.1 to 100 μm and with the height of said pillar-structures being higher than approximately 1 μm, preferably being higher than 10 μm.

3. Device according to claim 1,
wherein said at least one separation zone is positioned adjacent to or in said loading zone, said transport zone and/or said LDI detection zone.

4. Device according to claim 3,
wherein said separation zone further comprises a physical, chemical and/or biological functionality to allow separating said at least one analyte from other components of said sample.

5. Device according to claim 4,
wherein said physical functionality is provided by said elevated structures with a form, dimensions and spacing to allow separating said at least one analyte from other components of said sample.

6. Device according to claim 4,
wherein said chemical functionality is provided by coatings of hydrophobic, hydrophilic, IMAC and/or ionic nature to allow separating said at least one analyte from other components of said sample.

7. Device according to claim 4,
wherein said biological functionality allows to separate said at least one analyte from other components of said sample by affinity based interactions.

8. Device according to claim 1,
wherein said zone for LDI detection comprises at least one metal and/or at least one energy absorbing molecule (EAM) being capable for use as matrix material in matrix assisted laser desorption ionization mass spectrometry (MALDI-MS) and/or at least one calibrant.

9. Device according to claim 8,
wherein said zone for LDI detection comprises at least one metal or alloy selected from the group comprising gold, silver, platin, palladium, chromium, titanium and copper.

10. Device according to claim 8,
wherein said zone for LDI detection comprises at least one matrix selected from the group comprising derivatives of benzoic acid, cinnamic acid, and related aromatic compounds, e.g. 2,5-dihydroxybenzoic acid (2,5-DHB or gentisic acid), α-cyano-4-hydroxy cinnamic acid (CHCA), 3,5-dimethoxy-4-hydroxy cinnamic acid (sinapic acid, sinapinic acid or SPA), nicotinic acid, picolinic acid, trans-3-methoxy-4-hydroxy cinnamic acid (ferulic acid) 2-(4-hydroxyphenylazo)-benzoic acid (HABA), 6-aza-2-thiothymine (ATT), 3-HPA, succinic acid, glycerol, 4-hydroxypicolinic acid, tartaric acid, glycerine, 2,4,6-trihydroxy acetophenone, 3-hydroxypicolinic acid, 3-aminoquino line, 1,8,9-trihydroxy-anthracene (dithranol), the laser dye coumarin 120, substituted pyrimidines, pyridines, and anilines, e.g. para-nitroaniline.

11. Method of determining the presence and/or amount of at least one analyte in a sample comprising the steps of:
a) providing a device for separating at least one analyte in a liquid sample comprising at least one substrate with:
at least one zone for loading a liquid sample;
at least one zone for transporting said liquid sample; and
at least one zone for separating said at least one analyte from other components of said liquid sample;
wherein said at least one transport zone comprises an array of elevated structures of a form, dimensions and/or spacing in between said elevated structures such that a capillary force-driven flow of said sample from said loading zone trough said separation zone is achieved;
b) loading a sample onto the loading zone of said device of step a);
c) separating said at least one analyte from other components of a said sample using said device of a);
d) determining the presence and/or amount of said at least one analyte by MALDI-MS.

12. Method according to claim 11,
wherein said elevated structures have pillar-like forms with the spacing between said pillar-structures being in the range of approximately 0.1 to 1000 μm, preferably in the range of approximately 0.1 to 100 μm and with the height of said pillar-structures being higher than approximately 1 μm, preferably being higher than 10 μm.

13. Method according to claim 11,
wherein said device further comprises at least one zone for LDI detection comprising at least one metal and/or at least one energy absorbing molecule (EAM) being capable for use as matrix material in matrix assisted laser desorption/ionization mass spectrometry (MALDI-MS) and/or at least one calibrant.

14. Method according to claim 13,
wherein said zone for LDI detection comprises a metal or alloy selected from the group comprising gold, silver, platin, palladium, chromium, titanium and copper.

15. Method according to claim 13,
wherein said zone for LDI detection comprises a matrix selected from the group comprising derivatives of benzoic acid, cinnamic acid, and related aromatic compounds, e.g. 2,5-dihydroxybenzoic acid (2,5-DHB or gentisic acid), α-cyano-4-hydroxy cinnamic acid (CHCA), 3,5-dimethoxy-4-hydroxy cinnamic acid (sinapic acid, sinapinic acid or SPA), nicotinic acid, picolinic acid, trans-3-methoxy-4-hydroxy cinnamic acid (ferulic acid) 2-(4-hydroxyphenylazo)-benzoic acid (HABA), 6-aza-2-thiothymine (ATT), 3-HPA, succinic acid, glycerol, 4-hydroxypicolinic acid, tartaric acid, glycerine, 2,4,6-trihydroxy acetophenone, 3-hydroxypicolinic acid, 3-aminoquinoline, 1,8,9-trihydroxy-anthracene (dithranol), the laser dye coumarin 120, substituted pyrimidines, pyridines, and anilines, e.g. para-nitroaniline.

16. Method according to claim 11,
wherein said at least one separation zone is positioned adjacent to or in said loading zone, said zone transport zone and/or said LDI detection zone.

17. Method according to claim 16,
wherein said separation zone further comprises a physical, chemical and/or biological functionality to allow separating said at least one analyte from other components of said sample.

18. Use of a device comprising at least one substrate with:
at least zone for loading a liquid sample;
at least one zone for transporting said liquid sample; and
at least one zone for separating said at least one analyte from other components of said liquid sample;
wherein said at least one transport zone comprises an array of elevated structures of a form, dimensions and/or spacing in between said elevated structures such that a capillary force-driven flow of said sample from said loading zone trough said separation zone is achieved;
for separating at least one analyte in a liquid sample and subsequent determination of the presence and/or amount of said at least one analyte by LDI and preferably MALDI detection.

19. Use according to claim 18,
wherein said device further comprises at least one zone for LDI detection comprising at least one metal and/or at least one energy absorbing molecule (EAM) being capable for use as matrix material in matrix assisted laser desorption ionization mass spectrometry (MALDI-MS).
